(19) United States
(12) Patent Application Publication
(10) Pub. No.: US 2006/0025507 A1
(43) Pub. Date: Feb. 2, 2006

(54) Low wear resin composition having improved surface appearance

(76) Inventors: David T. Moore, Cincinnati, OH (US); Vincent J. Notorgiacomo, Erlanger, KY (US)

Correspondence Address: FERRELLS, PLLC, P. O. BOX 312, CLIFTON, VA, 20124-1706, US

(21) Appl. No.: 10/899,281

(22) Filed: Jul. 26, 2004

(51) Int. Cl. C08L 91/06

(52) U.S. Cl. 524/275

(57) ABSTRACT

A low wear polyoxymethylene composition includes a polyoxymethylene matrix resin; from about 0.05 to about 3 weight percent of a high molecular weight polyethylene having an intrinsic viscosity of from about 3.5 dl/g to about 35 dl/g, with the provisos that the high molecular weight polyethylene is further characterized by either: (i) an intrinsic viscosity of less than about 10 dl/g; or (ii) a particle size, d₅₀, of less than about 50 microns as provided to the composition. The composition also includes an oxidized polyolefin wax; and optionally includes one or more of additional lubricants, reinforcing agents and stabilizers. The compositions are useful for tribological applications and are used to make bearings, gears, cams, rollers, sliding plates, conveyor belt links, castors, fasteners, levers and the like.

### BACKGROUND OF THE INVENTION

1. Field of the Invention

The field of art to which this invention relates is lubricated polyoxymethylene (POM) resin compositions for use in tribological applications.

2. Description of the Prior Art

It is known to use high molecular weight polyolefins as lubricants to improve the wear resistance of polyoxymethylene resins. For example, U.S. Pat. No. 5,482,987 discloses self-lubricating, low wear compositions containing from about 70 to about 99.5 weight percent of a thermoplastic polymer, e.g., polyoxymethylene, and 0.5 to 30 weight percent of a lubricating system comprising a high molecular weight polyethylene, a high density polyethylene, and other components as therein more particularly described; said high molecular weight polyethylene being further described as exhibiting a molecular weight of at least about 500,000, a density of at least about 0.94 g/cm³, and what is therein termed a mold flow index (MFI) of from about 0.4 to about 2.2 g/10 minutes, and said high density polyethylene being further described as exhibiting a density of about 0.95 g/cm³ and a MFI of about 3.0 g/10 minutes. U.S. Pat. No. 5,641,824 discloses a self lubricating melt blend of from about 70 to about 99.5 weight percent of a thermoplastic polymer, e.g., polyoxymethylene, and from about 0.5 to 30 weight percent of a lubricating system containing ultra high molecular weight polyethylene having a weight-average molecular weight of at least about 3×10⁶, typically from about 5×10⁶ to about 6×10⁶, together with other components as therein more particularly described. The ultra high molecular weight polyethylene component of the compositions disclosed by U.S. Pat. No. 5,641,824 is further described as having an intrinsic viscosity of at least about 28 dl/g and a specific gravity of about 0.93g/cm³.

The use of ultra high molecular weight polyethylene as an additive in polyoxymethyene compositions is also disclosed by JP 01126359A and U.S. published Pat. Appln. No.20030148117. More specifically, JP 01126359A discloses a blend of 100 parts by weight polyacetal, 1 to 6 parts by weight of oil and/or wax and 1 to 15 parts by weight of ultra high molecular weight polyethylene having a particle diameter of less than or equal to 30 μm. U.S. published Pat. Appln. No. 20030148117 discloses a polyacetal resin composition comprising a polyacetal resin having a melt index of 3.0 or less and, based on the weight of the composition: 0.05 to 3.0 wt % of silicone oil, 0.1 to 5.0 wt % of an elastomer, and 0.1 to 5.0 wt % of ultra high molecular weight polyethylene; the ultra high molecular weight polyethylene component is said to have a weight average molecular weight of not lower than about 1,000,000 and a preferred average particle diameter of 15 to 150 μm.

EP 498620A discloses a colored polyacetal resin composition comprising: (A) 100 parts by weight of a polyacetal resin, (B) 0.1 to 30 parts by weight, in terms of carbon black, of a substantially uniform dispersion of a carbon black integrated into an ethylenic polymer, the amount of the said polymer being 0.3 to 8 times that of the carbon black, (C) 0.01 to 5 parts by weight of one or more compounds selected from among nitrogen compounds, fatty acid esters and metal compounds consisting of hydroxides, inorganic acid salts and carboxylates of alkali metals and alkaline earth metals, and (D) 0.01 to 5 parts by weight of a hindered phenolic compound. EP 498620A discloses the following materials as suitable for use as the polyethylene component of the compositions therein described: low-density polyethylene, high-density polyethylene, ethylene vinyl acetate copolymers, ethylene-acrylic ester copolymers, ethylene-e-olefin copolymers, modified ethylene copolymers, and polyethylene wax.

U.S. Pat. No. 6,046,141 discloses the use of ultrahigh molecular polyethylene as one of many additional optional processing aids that may be present in molding compositions comprising from about 95 to 99.9 parts by weight of a thermoplastic selected from the class consisting of polyacetals, polyesters, and polyamides and from about 0.1 to 5 parts by weight of an oxidized polyethylene wax.

While the addition of high molecular weight polyethylene is known to improve many of the wear characteristics of polyoxymethylenes, parts made from blends of polyoxymethylene and high molecular weight polyethylene commonly have a less than desirable surface appearance. More particularly, such blends commonly exhibit pitting, surface roughness, blotches, striations, and/or splaying, defects that may limit their use in applications where surface appearance is important. Without wishing to be bound to theory, some of these surface defects may be indications of blend delamination. In addition to contributing to surface defects, delamination may, in some instances, detract from the wear properties of the blends.

A polyoxymethylene composition that has both good wear properties and good surface appearance is desired.

### SUMMARY OF THE INVENTION

It has been unexpectedly found that polyoxymethylene based compositions provided with an oxidized polyolefin lubricant as well as a high molecular weight particulate polyethylene resin provide dramatically superior surface and wear resistance. Selecting a suitable particle size is also important when very high molecular weight polyethylene resin is used. There is thus provided in one aspect of the invention a low wear polyoxymethylene composition including: a polyoxymethylene matrix resin; from about 0.05 to about 3 weight percent of a high molecular weight polyethylene having an intrinsic viscosity of from about 3.5 dl/g to about 35 dl/g, with the provisos that the high molecular weight polyethylene is further characterized by either: (i) an intrinsic viscosity of less than about 10 dl/g; or (ii) a particle size, d₅₀, of less than about 50 microns as provided to the composition; an oxidized polyolefin wax; and optionally including one or more of additional lubricants, reinforcing agents and stabilizers. Typically, the high molecular weight polyethylene has an intrinsic viscosity of from about 3.5 dl/g to about 20 dl/g; in one preferred embodiment, the high molecular weight polyethylene has an intrinsic viscosity of from about 5 dl/g to about 10 dl/g. In another preferred case, the high molecular weight polyethylene has a particle size, d₅₀, of less than about 35 microns as supplied to the composition and the resin has an intrinsic viscosity greater than 10 dl/g. The high molecular weight polyethylene is preferably present in an amount of from about 0.1 to about 2 weight percent such as from about 0.2 to about 1.5 weight percent.

The oxidized polyolefin wax typically has a viscosity of from about 1,000 to about 10,000 mPa·s@140° C. such as from about 2,000 to about 8,000 mPa·s@140° C. One preferred oxidized polyolefin has a viscosity of about 5,000 mPa·s@140° C. Most preferably, the oxidized polyolefin wax is an oxidized polyethylene wax. Generally, the oxidized polyolefin wax has an acid number of from about 10 to about 20 mgKOH/g.

Preferably, the polyoxymethylene matrix resin has an MI of from about 2 g/10 min to about 8 g/10 min measured in accordance with ASTM D1238 and is a copolymer comprising oxymethylene and oxyethylene recurring units.

Typically, the composition includes at least one additional lubricant such as a lubricant selected form the group consisting of: silicone lubricants, pentaerythritol tetrastearate, polytetrafluoroethylene, calcium carbonate and mineral oil. Pentaerythritol tetrastearate is an especially prefrerrred additional lubricant. Another preferred embodiment includes at least one component selected from the group consisting of: plasticizers, formaldehyde scavengers, antioxidants, fillers, reinforcing agents, stabilizers, pigments and colorants.

A molded article produced from the resin composition is in some cases selected from the group consisting of bearings, gears, cams, rollers, sliding plates, conveyor belt links, castors, fasteners and levers.

Another aspect of the invention is a low wear polyoxymethylene composition consisting essentially of: a polyoxymethylene matrix resin; from about 0.05 to about 3 weight percent of a high molecular weight polyethylene having an intrinsic viscosity of from about 3.5 dl/g to about 35 dl/g, with the provisos that the high molecular weight polyethylene is further characterized by either: (i) an intrinsic viscosity of less than about 10 dl/g; or (ii) a particle size, d₅₀, of less than about 50 microns as supplied to the composition; an oxidized polyolefin wax; and optionally including one or more of additional lubricants, reinforcing agents and stabilizers . This embodiment excludes additional components which would alter the basic and novel characteristics of the composition, that is, those components which change the surface or wear properties.

Another aspect of the invention is a method of making low wear article of manufacture including the steps of (a) melt-blending a composition including: a polyoxymethylene matrix resin with from about 0.05 to about 3 weight percent of a high molecular weight, particulate polyethylene resin having an intrinsic viscosity of from about 3.5 dl/g to about 35 dl/g, with the provisos that the high molecular weight polyethylene is characterized by either: (i) an intrinsic viscosity of less than about 10 dl/g; or (ii) a particle size, d₅₀, of less than about 50 microns as supplied to the composition and an oxidized polyolefin wax; and optionally further including additional lubricants, reinforcing agents and stabilizers and (b) injection molding the melt-blended composition of step (a) into a shaped article. Preferaby, the process further includes the step of pelletizing the melt-blended composition prior to injection molding the shaped article which is selected from the group consisting of bearings, gears, cams, rollers, sliding plates, conveyor belt links, castors, fasteners and levers. The particulate high molecular weight polyethylene resin may have has a particle size, d₅₀, of from about 20 microns to about 150 microns; however, at higher molecular weights, the particulate high molecular weight polyethylene resin preferably has a particle size, d₅₀, of less than about 35 microns.

### DETAILED DESCRIPTION OF THE INVENTION

The invention is described herein with reference to particular materials and compositions for purposes of illustration only. Modifications within the spirit and scope of the invention, set forth in the appended claims, will be readily apparent to one of skill in the art.

As used herein, terminology is used with its ordinary meaning unless more specifically defined below.

Unless otherwise indicated, intrinsic or relative viscosity is determined in accordance with ASTM test method D 4020-01a. This value is sometimes referred to as a relative viscosity.

Melt Index or MI is determined in accordance with ASTM test method D 1238.

Unless otherwise specified, a test method referred to is the test method in effect as of Jul. 1, 2004.

Particle size may be determined by any suitable technique such as sieving, optical methods, aerodynamic methods or by way of electrolytic resistance of a suspension of particles as it is pumped through an aperture and so forth. Such techniques are well known. Particle size, d₅₀, refers to a diameter as to which 50 weight percent of the specified particles have a smaller diameter. D₉₀ refers to a diameter as to which 90 weight percent of the specified particles have a smaller diameter.

Percent means weight percent unless otherwise specified. Weight percent is calculated based on the recited components unless otherwise indicated.

Polyoxymethylenes, i.e., polyacetals or oxymethylene polymers, useful in the present invention are generally characterized as having recurring oxymethylene units of general formula: [symbol]
O—CH₂ [symbol] .
In general, the oxymethylene units will constitute at least about 85% of the recurring units of such polymers.

Polyoxymethylenes are commercially available from a number of manufacturers as homo- or copolymers. These polymers are well known in the art and have been reviewed extensively. Information on polyacetals may be found in “Acetal Resins,” by T. J. Dolce and John A. Grates, Second Edition of Encyclopedia of Polymer Science and Engineering, John Wiley and Sons, New York, 1985, Volume 1. pp. 46-₆₁. Additional information on acetal polymers can be found in French Patent No. 1,221,148 as well as U.S. Pat. Nos. 3,027,352, 2,072,069, 3,147,234, and 3,210,318.

Acetal homopolymers may be prepared by polymerizing anhydrous formaldehyde or trioxane, a cyclic trimer of formaldehyde. For example, high molecular weight acetal polyoxymethylenes have been prepared by polymerizing trioxane in the presence of certain fluoride catalysts, such as for example, antimony fluoride, and may also be prepared in high yields and at rapid reaction rates by the use of catalysts comprising boron fluoride coordination complexes with organic compounds, as described, for example, in U.S. Pat. No. 2,989,506 to Hudgin et al.

Typically, such homopolymers are stabilized against thermal degradation by end-capping with, for example, ester or ether groups, such as those derived from alkanoic anydrides (e.g. acetic anhydride) or dialkyl ethers, (e.g. dimethyl ether), Methods of making end-capped acetal homopolymers are taught in U.S. Pat. No. 2,998,409. Commonly, the homopolymers are end-capped by reacting the hemiactal groups with acetic anhydride in the presence of sodium acetate catalyst. Acetal homopolymers are well known in the art and are commercially available from numerous suppliers.

The oxymethylene copolymer suitable for use herein will usually possess a relatively high level of polymer crystallinity, i.e., about 60 to 80 percent or higher. The preferred oxymethylene copolymers have repeating units which consist essentially of oxymethylene groups interspersed with oxy(higher alkylene) groups of the general formula: 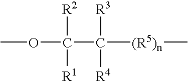
wherein R¹ through R⁴ are independently selected from the group consisting of hydrogen and lower alkyl, R⁵ is selected from the group consisting of methylene, oxymethylene, lower alkyl-substituted methylene and lower alkyl-substituted oxymethylene, and n is an integer from zero to three, inclusive. As used throughout the specification and claims, the term “lower alkyl” refers to an alkyl group having 1 to 4 carbon atoms. Optionally, one or more of these lower alkyl groups may be halogen substituted. Preferably, R¹ through R⁴ are independently selected from hydrogen and lower alkyl having from 1 to 2 carbon atoms.

Oxymethylene groups will generally constitute from about 85 to about 99.9 percent of the recurring units of the oxymethylene copolymers. Of particular interest in the practice of this invention are oxymethylene copolymers that consist essentially of oxymethylene and oxyethylene units.

Polyoxymethylene copolymers can be prepared by the copolymerization of formaldehyde (or a cyclic oligomer thereof such as trioxane or tetraoxane) with one or more comonomers such as, for example, a cyclic ether or cyclic formal having a least two adjacent carbon atoms, in the presence of a suitable catalyst such as, for example, a Lewis acid (e.g. BF₃. PF₅, and the like) or other acids (e.g., HClO₄, 1% H₂SO₄, and the like), ion pair catalysts, etc . . . Among the cyclic ether and cyclic formals that may be used in preparing the oxymethylene copolymers are: ethylene oxide, 1,3-dioxolane, 1,3-dioxane, trimethylene oxide, 1,2-propylene oxide, 1,3-butylene oxide, 1,4-butandediol formal, diethylene glycol formal, and the like. The cyclic ether and cyclic formal of particular interest in preparing the oxymethylene copolymers are ethylene oxide and 1,3-dioxolane, respectively. The preparation of oxymethylene copolymers is described, for example, in U.S. Pat. Nos. 3,027,352; 3,519,696; and 3,848,021.

Typically, oxymethylene copolymers are stabilized after polymerization by degradation of unstable molecular ends of the polymer chains to a point where a relatively stable carbon-to-carbon linkage prevents further degradation of each end of the polymer chain. Such degradation of unstable molecular ends is generally effected by hydrolysis, as disclosed, for example, in U.S. Pat. No. 3,219,623 to Berardinelli. Oxymethylene copolymers may also be stabilized by end-capping, again using techniques well known to those skilled in the art, as for example, by acetylation with acetic anhydride in the present of a sodium acetate catalyst.

A particularly preferred class of oxymethylene copolymers is commercially available under the trademark Celcon® from Ticona, the engineering resins business of Celanese AG.

Desirably, the oxymethylene polymers used in the practice of this invention have a melting point of at least about 150° C., with oxymethylene polymers having melting points of at least about 165° C. being of particular interest. They normally are millable or processible at temperatures ranging from about 180° C. to about 200° C. The oxymethylene polymers typically have molecular weights (weight-average) M_{w} in the range from 5000 to 200,000, with polymers having molecular weights (M_{w}) of from about 10,000 to about 150,000 being of particular interest. The polyoxymethylene polymers used herein generally having a melt index (MI) of from about 1.5 g/10 min. to about 45 g/10 min. when tested in accordance with ASTM D1238, with polymers having an MI of from about 2 g/10 min to about 8 g/10 min being of particular interest.

The high molecular weight polyethylene used in the practice of this invention suitably has an intrinsic or relative viscosity measured in accordance with ASTM D4020-01a of from about 3.5 dl/g to about 35 dl/g. Molecular weight may be calculated by way of the Mark-Houwink equation if so desired; suitable molecular weights include the range of from about 500,000 g/mol to about 5,000,000 g/mol.

In addition the inherent viscosities and molecular weights within the range described above, the high molecular weight polyethylene may have an average particle size (d₅₀) of less than about 140 microns with at least 90% of the particles having a particle size of less than about 220 microns. Of particular interest in the practice of this invention is the use of HMWPE having an average particle size (d₅₀) of from about 100 microns to about 140 microns wherein at least 90% of the particles having a particle size of less than about 220 microns. The particle size and particle size distribution of preference depends, to some extent, on the molecular weight of the HMWPE. Without wishing to be bound to theory, it is believed that the HMWPE component tends to exhibit greater deformation under pressure within the lower region of described average molecular weight range than at the higher region of this region. That is to say, the sensitivity to particle size is increased as the molecular weight of the HMWPE component is increased. Thus, within the higher region of the average molecular weight range of interest; it is preferable for the HMWPE to be in the form of smaller particles and to have a narrower particle size distribution. For example, in the case of HMWPE having an intrinsic viscosity of 7±3 dl/g, the average particle size (d₅₀) of preference is from about 110 microns to about 130 microns and the particle size distribution of preference is such that at least 90% of the particles have a particle size of less than about 170 microns.

Numerous processes are known for the preparation of high molecular weight polyethylene. One such process, described in DE- B 23 61 508, is carried out under low pressure using a mixed catalyst of titanium (III) halides and organoaluminum compounds. Other processes, which are also carried out under low pressures, use, for example, chromium oxide catalysts. The particle size and particle size distribution of the high molecular weight polyethylene is obtained by conventional milling and sieving techniques.

High molecular weight polyethylene suitable for use in the practice of this invention is available from suppliers that include Ticona, the engineering resins business of Celanese AG. One resin of particular interest is a high molecular weight polyethylene available from Ticona under the designation GUR® 8110 PE. GUR® 8110 PE intrinsic viscosity of 7±3 dl/g, and average particle size (d₅₀) of 120 μm±20 μm with at least 90% of the particles having a particle size of less than 220 microns.

The oxidized polyolefin used in the practice of this invention typically has a viscosity of about 5000 mPa·S@140° C. or thereabouts. The oxidized polyolefin is further characterized as having an acid number of from about 10 to about 20 mg KOH/g according to ASTM D1386. The acid number provides a measure of the extent of oxidation of the polyolefin wax. Oxidized polyethylene is produced by the mild air oxidation of polyethylene. It may contain up to a maximum of 5% by weight total oxygen in most cases and usually has an acid value of from about 10 to 20. Oxidized or polar polyethylene waxes are represented by the structure: 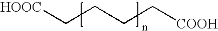
Where n is a suitable integer, preferably being such that the viscosity of the wax is from about 1,000 to about 10,000 mPa·S@140° C.

The preparation of oxidized polyolefin wax is well known in the art and generally involves the oxidation of polyolefin wax with oxygen or oxygen containing gases, typically at elevated temperatures and pressures. Oxidized polyolefin waxes include oxidized homopolymers or copolymers of C₂ to C₁₀ polyolefins, for example, ethylene, propylene, butene, and the like. Preparative techniques for the preparation of oxidized polyolefin wax is described, for example, in DE A 1 180 131, DE 2035706, DE 3047915 and DE 2201862. The use of oxidized polyethylene wax is of particular interest in the practice of this invention. Suitable waxes are disclosed in U.S. Pat. No. 3,756,999 to Stetter et al. as well as U.S. Pat. No. 6,211,303 to Hohner.

Suitable oxidized polyolefin waxes are commercially available from Clariant Corporation. An oxidized polyethylene wax available from Clariant Corporation under the designation Licowax PED 191 is of particular interest in the practice of this invention.

Optionally, the compositions of this invention may further contain additives such as plasticizers, formaldehyde scavengers, antioxidants, fillers, reinforcing agents, stabilizers, pigments, colorants, and the like. Additional lubricants may also be present, so long as such additional lubricants do not materially negatively impact the wear and surface properties of the subject compositions. Suitable additional lubricants include additives such as, for example, silicone lubricants, pentaerythritol tetrastearate, polytetrafluoroethylene (PTFE), calcium carbonate, mineral oil, and the like.

The compositions of this invention may be prepared by conventional compounding techniques wherein the polyoxymethylene, high molecular weight polyethylene, oxidized polyolefin wax, and, when present, any other additional additives or components, are combined under conditions of elevated temperature and shear. The order in which the components are combined is not critical; if desired, the various components can be combined in a single or multiple steps. Typically, the compositions are prepared by extrusion compounding of the components at melt temperatures of from about 180° C. to about 220° C. Depending upon the particular components utilized and their relative amounts, the use of melt temperatures in excess of about 235° C. can result in polymer degradation.

The compositions of this invention are useful in the production of a variety of molded articles, including, for example, articles where low friction properties and resistance to surface wear under load are desired. Articles of interest include, for example, bearings, gears, pulleys, cams, rollers, sliding plates, conveyor belt links, castors, fasteners, and levers.

### EXAMPLES

The following examples are presented to further illustrate this invention. The examples are not, however, intended to limit the invention in any way. The tests hereinafter described were performed on samples molded from compositions prepared in accordance with the examples. Unless otherwise indicated, all parts and percentages are by weight, based on total composition weight.

Materials referred to in the examples set forth below are as follows:
POM Copolymer: Celcon M90, minor amount of Celcon O10 (Ticona. LLC)
Polyethylene A: polyethylene having an intrinsic viscosity of 30±3 dl/g (average molecular weight of approximately 9.2×10⁶ g/mol), an average particle size (d₅₀) of 120 μm±20 μm and a D₉₀ of 210 μm
Polyethylene B: polyethylene having an intrinsic viscosity of 10±3 dl/g (average molecular weight of approximately 1.0×10⁶ g/mol), an average particle size (d₅₀) of 150 μm±30 μm and a D₉₀ of 230 μm
Polyethylene C: polyethylene having an intrinsic viscosity of 21±3 dl/g (average molecular weight of 4.5×10⁶ g/mol), an average particle size (d₅₀) of 32 μm±4 μm and a D₉₀ of 80 μm
Polyethylene D: polyethylene having an intrinsic viscosity of 7±3 dl/g (average molecular weight of approximately 6.1×10⁵ g/mol), an average particle size (d₅₀) of 120 μm±20 μm and a D₉₀ of 220 μm
Oxidized Polyethylene: Licowax PED 191, an oxidized polyethylene wax from Clariant Corporation (CAS No. 68441-17-8).
Montan Wax Ester A: Licowax E (Clariant Corporation)
Montan Wax Ester B: Licowax OP (Clariant Corporation)

Stabilizers and additives included calcium carbonate, hindered phenols and so forth as are known in the art.

Compositions as described in Table 1 and 2 were compounded by tumble blending the components in the described proportions and melt blending the resulting mixtures on a 25 mm co-rotating twin screw extruder to produce an extrudate which was cooled and pelletized. Extrusion conditions were as follows:
melt temperature: 215° C. to 225° C.
die temperature: 205° C.
throughput rate: 23 Kg/hr.
screw speed: 225 rpm

The compositions prepared as described above were then molded into 4 inch diameter×⅛ thick disks, as well as thrust washer and wear disks of the dimensions described in ASTM D 3702. Conditions during molding were as follows.
melt temperature: 200° C.
mold temperature: 90° C.
cycle time: 57 seconds
screw speed: 60 rpm
   The surface appearance of the molded 4 inch diameter disks was evaluated visually and the molded specimens given a surface appearance rating of 1 to 10, with the surface appearance rating increasing as the quality of the surface improved. Ratings of 1 to 3 indicated a very poor surface appearance, typified by extensive and relatively deep pitting, as well as blotches, and/or splay; ratings of 4 to 7 indicated pitting of varying extent and depth, as well as some splay; ratings of 8 to 9 indicated relatively smooth surfaces with very slight and shallow pitting, as well as little or no splay; and a rating of 10 indicated a uniformly smooth surface that was essentially free of pitting. Surface appearance ratings of the compositions are reported in Tables 1 and 2. C₁, a polyoxymethylene composition containing no high molecular weight polyethylene, had the best surface of the reported compositions. As demonstrated by C₂, C₅, C₈, and C₁₁, the addition of a high molecular weight polyethylene, but no oxidized polyethylene wax, resulted in a deterioration of the surface appearance of the polyoxymethylene composition. Certain high molecular weight polyethylenes when added with the oxidized polyethylene resulted in specimens with a good surface appearance; compare, for example C₃ and C₄, C₆ and C₇, and C₉ and C₁₀ with E₁ and E₂.

The wear properties of several of the molded specimens was measured following the procedures of ASTM D3702 with the following modifications to the reported procedures:
Wear testing against steel: the test interval was shortened and wear factors were calculated using the change in height that occurred during the interval of 1,000 to 1,400 minutes.
Wear testing against self: testing was done using a thrust washer disk that was tested against a molded 4 inch diameter×⅛ inch thick disk of the same material; the test interval was shortened and wear factors were calculated using the change in height that occurred during the interval of 1,000 to 1,400 minutes. In the wear testing against self, wear performance was measured at a speed of 50 feet per minute and pressures of 20 and 40 psi (to provide PV ratings of 1000 and 2000, respectively), as well as at a speed of 150 feet per minute and pressures of 6.6 and 13.3 psi (to provide PV ratings of 1000 and 2000, respectively).

Wear data is reported in Table 3.

TABLE 1

| COMPONENT | COMPOSITION | | | | | | | | | | | | |
|---|---|---|---|---|---|---|---|---|---|---|---|---|---|
| (WEIGHT %) | C₁ | C₂ | C₃ | C₄ | C₅ | C₆ | C₇ | C₈ | C₉ | C₁₀ | C₁₁ | E₁ | E₂ |
| Polyoxymethylene Copolymer | 97.4 | 95.9 | 95.9 | 95.6 | 95.9 | 95.9 | 95.6 | 95.9 | 95.9 | 95.6 | 95.9 | 95.9 | 95.6 |
| Polyethylene A | — | 1.5 | 1.3 | 1.3 | — | — | — | — | — | — | — | — | — |
| Polyethylene B | — | — | — | — | 1.5 | 1.3 | 1.3 | — | — | — | — | — | — |
| Polyethylene C | — | — | — | — | — | — | — | 1.5 | 1.3 | 1.3 | — | — | — |
| Polyethylene D | — | — | — | — | — | — | — | — | — | — | 1.5 | 1.3 | 1.3 |
| Oxidized Polyethylene | — | — | 0.2 | 0.5 | — | 0.2 | 0.5 | — | 0.2 | 0.5 | — | 0.2 | 0.5 |
| Pentaerythritol Tetrastearate | 1.0 | 1.0 | 1.0 | 1.0 | 1.0 | 1.0 | 1.0 | 1.0 | 1.0 | 1.0 | 1.0 | 1.0 | 1.0 |
| Stabilizers/Additives | 1.6 | 1.6 | 1.6 | 1.6 | 1.6 | 1.6 | 1.6 | 1.6 | 1.6 | 1.6 | 1.6 | 1.6 | 1.6 |
| Surface Appearance Rating | 10 | 1 | 1 | 1 | 2 | 2 | 2 | 3 | 6 | 8 | 1 | 10 | 9 |

TABLE 2

| | Composition | | | | | | | | |
|---|---|---|---|---|---|---|---|---|---|
| COMPONENT (WEIGHT %) | C₁₂ | C₁₃ | C₁₄ | C₁₅ | E₃ | E₄ | C₁₆ | E₅ | E₆ |
| Polyoxymethylene Copolymer | 95.9 | 95.9 | 95.9 | 95.9 | 95.9 | 95.9 | 95.9 | 96.9 | 95.9 |
| Polyethylene D | 1.5 | 1.3 | 1.3 | 1.3 | 1.3 | 1.3 | 1.3 | 1.3 | 1.3 |
| Oxidized Polyethylene | — | — | — | — | 0.2 | 0.2 | — | 0.2 | 1.2 |
| Polyethylene Wax | — | 0.2 | — | — | — | — | — | — | — |
| Montan Wax Ester A | — | — | 0.2 | — | — | — | — | — | — |
| Montan Wax Ester B | — | — | — | 0.2 | — | — | — | — | — |
| N,N′-Ethylene Bis Stearamide | — | — | — | — | — | — | 0.2 | — | — |
| Pentaerythritol Tetrastearate | 1.0 | 1.0 | — | 1.0 | 1.0 | 1.0 | 1.0 | — | — |
| Stabilizers/Additives | 1.6 | 1.6 | — | 1.6 | 1.6 | 1.6 | 1.6 | 1.6 | 1.6 |
| Surface Appearance Rating | 1 | 2 | 2 | 2 | 8 | 9 | 1 | 9 | 9 |

TABLE 3

| | | System Wear vs. | System Wear vs. | System Wear vs. | System Wear vs. |
|---|---|---|---|---|---|
| | | Self @ 50 fpm | Self @ 50 fpm | Self @ 150 fpm | Self @ 150 fpm |
| Composition | Wear vs. Steel | PV = 1,000 | PV = 2,000 | PV = 100 | PV = 2,000 |
| C₁ | 326 | 37,707 | 77,237 | 16,632 | 132,281 |
| C₂ | 219 | 3,702 | 2,458 | 2,657 | 43,001 |
| C₆ | 220 | 28,268 | 44,786 | 30,769 | 189,747 |
| E₁ | 233 | 32,331 | 52,652 | 19,615 | 85,362 |
| E₄ | — | — | 43,164 | 20,374 | 57,712 |
| E₅ | — | 31,340 | 62,976 | — | — |
| E₆ | 75 | 12,315 | 39,304 | 15,922 | 54,459 |

It is seen from Tables 1 and 2 that the HMWPE with an intrinsic viscosity of 7 dl/g exhibited superior surface appearance only when the oxidized polyolefin was used, but did so even when the particle size (d₅₀) was greater than 100 microns. On the other hand, compositions having higher molecular weight polyethylene components having an intrinsic viscosity of greater than 10 dl/g or so exhibited superior surface only when the particle size of the HMWPE supplied to the composition was less than 50 microns or so and the oxidized polyethylene was employed. Compare compositions C₈, C₉ and C₁₀. Thus, molecular weight and particle size of the HMWPE as well as the oxidized polyolefin all play important roles in providing superior surface appearance and wear resistance.

With respect to the wear data in Table 3, it is seen that the compositions and parts of the invention exhibit wear properties comparable to compositions with HMWPE but without oxidized polyolefin; compare C₆ vs. E₁. However, compositions with HMWPE and elevated levels of oxidized polyolefin (at least 1%) appeared to perform better.

While the invention has been described in connection with several examples, modifications to these examples within the spirit and scope of the invention will be readily apparent to those of skill in the art. In view of the foregoing discussion, relevant knowledge in the art and references discussed above in connection with the Background and Detailed Description, the disclosures of which are all incorporated herein by reference, further description is deemed unnecessary.

What is claimed is:

1. A low wear polyoxymethylene composition comprising:
a) a polyoxymethylene matrix resin;
b) from about 0.05 to about 3 weight percent of a high molecular weight polyethylene having an intrinsic viscosity of from about 3.5 dl/g to about 35 dl/g, with the provisos that high molecular weight polyethylene is further characterized by either: (i) an intrinsic viscosity of less than about 10 dl/g; or (ii) a particle size, d₅₀, of less than about 50 microns as provided to the composition;
c) an oxidized polyolefin wax; and
d) optionally including one or more of additional lubricants, reinforcing agents and stabilizers.

2. The composition according to claim 1, wherein the high molecular weight polyethylene has an intrinsic viscosity of from about 3.5 dl/g to about 20 dl/g.

3. The composition according to claim 1, wherein the high molecular weight polyethylene has an intrinsic viscosity of from about 5 dl/g to about 10 dl/g.

4. The composition according to claim 1, wherein the high molecular weight polyethylene has a particle size, d₅₀, of less than about 35 microns as supplied to the composition.

5. The composition according to claim 1, wherein the high molecular weight polyethylene is present in an amount of from about 0.1 to about 2 weight percent.

6. The composition according to claim 1, wherein the high molecular weight polyethylene is present in an amount of from about 0.2 to about 1.5 weight percent.

7. The composition according to claim 1, wherein the oxidized polyolefin wax has a viscosity of from about 1,000 to about 10,000 mPa·s@140° C.

8. The composition according to claim 1, wherein the oxidized polyolefin wax has a viscosity of from about 2,000 to about 8,000 mPa·s@140° C.

9. The composition according to claim 1, wherein the oxidized polyolefin wax has a viscosity of about 5,000 mPa·s@140° C.,

10. The composition according to claim 1, wherein the oxidized polyolefin wax is an oxidized polyethylene wax.

11. The composition according to claim 1, wherein the oxidized polyolefin wax has an acid number of from about 10 to about 20 mgKOH/g.

12. The resin composition according to claim 1, wherein the polyoxymethylene matrix resin has an MI of from about 2 g/10 min to about 8 g/10 min measured in accordance with ASTM D1238.

13. The resin composition according to claim 12, wherein the polyoxymethylene matrix resin is a copolymer comprising oxymethylene and oxyethylene recurring units.

14. The resin composition according to claim 1, including at least one additional lubricant.

15. The resin composition according to claim 14, wherein the additional lubricant is selected form the group consisting of: silicone lubricants, pentaerythritol tetrastearate, polytetrafluoroethylene, calcium carbonate and mineral oil.

16. A resin composition according to claim 15, wherein said additional lubricant is pentaerythritol tetrastearate.

17. The resin composition according to claim 1, including at least one component selected from the group consisting of: plasticizers, formaldehyde scavengers, antioxidants, fillers, reinforcing agents, stabilizers, pigments and colorants.

18. A molded article produced from the resin composition of claim 1.

19. A molded article according to claim 18, wherein said molded article is selected from the group consisting of bearings, gears, cams, rollers, sliding plates, conveyor belt links, castors, fasteners and levers.

20. A low wear polyoxymethylene composition consisting essentially of:
a) a polyoxymethylene matrix resin;
b) from about 0.05 to about 3 weight percent of a high molecular weight polyethylene having an intrinsic viscosity of from about 3.5 dl/g to about 35 dl/g, with the provisos that the high molecular weight polyethylene is further characterized by either: (i) an intrinsic viscosity of less than about 10 dl/g; or (ii) a particle size, d₅₀, of less than about 50 microns as supplied to the composition; and
c) an oxidized polyolefin wax; and
optionally including one or more of additional lubricants, reinforcing agents and stabilizers.

21. A method of making low wear article of manufacture comprising:
a) melt-blending a composition including:
(i) a polyoxymethylene matrix resin;
(ii) from about 0.05 to about 3 weight percent of a high molecular weight, particulate polyethylene resin having an intrinsic viscosity of from about 3.5 dl/g to about 35 dl/g, with the provisos that the high molecular weight polyethylene being characterized by either: (i) an intrinsic viscosity of less than about 10 dl/g; or (ii) a particle size, d₅₀, of less than about 50 microns as supplied to the composition;
(iii) an oxidized polyolefin wax; and
(iv) optionally including additional lubricants, reinforcing agents and stabilizers; and
(b) injection molding the melt-blended composition of step (a) into a shaped article.

22. The method of claim 21, further comprising the step of pelletizing the melt-blended composition prior to injection molding the shaped article.

23. The method according to claim 21, wherein the shaped article is selected from the group consisting of bearings, gears, cams, rollers, sliding plates, conveyor belt links, castors, fasteners and levers.

24. The method according to claim 21, wherein the particulate high molecular weight polyethylene resin has a particle size, d₅₀, of from about 20 microns to about 150 microns.

25. The method according to claim 21, wherein the particulate high molecular weight polyethylene resin has a particle size, d₅₀, of less than about 35 microns.
